(19) United States
(12) Patent Application Publication
(10) Pub. No.: US 2024/0424953 A1
(43) Pub. Date: Dec. 26, 2024

(54) ELECTRIFIED VEHICLE AND CONTROL METHOD FOR THE SAME

(71) Applicants: Hyundai Motor Company, Seoul (KR); Kia Corporation, Seoul (KR)

(72) Inventors: Hyo Seung JEON, Pohang-si (KR); Soo Yang JIN, Hwaseong-si (KR)

(73) Assignees: Hyundai Motor Company, Seoul (KR); Kia Corporation, Seoul (KR)

(21) Appl. No.: 18/388,995

(22) Filed: Nov. 13, 2023

(30) Foreign Application Priority Data
Jun. 22, 2023 (KR) 10-2023-0080525

(51) Int. Cl. B60L 58/22; B60L 58/15

(52) U.S. Cl. CPC B60L 58/22; B60L 58/15

(57) ABSTRACT

An electrified vehicle includes first and second batteries, a power conversion device connected between the first and second batteries, and a controller determining the charging current command values for the first and second batteries from the value of the external charging current based on the charging limit currents for the first and second batteries and the charging current allocation ratio determined by the SOC value of the first and second batteries and controlling the power conversion device to allocate the external charging current to the first and second batteries according to the charging current command value.

### CROSS REFERENCE TO RELATED APPLICATION

The present application claims priority to Korean Patent Application No. 10-2023-0080525, filed Jun. 22, 2023, the entire contents of which is incorporated herein for all purposes by this reference.

### BACKGROUND OF THE PRESENT DISCLOSURE

### Field of the Present Disclosure

The present disclosure relates to an electrified vehicle configured to control the charging of a main battery and an auxiliary battery and a method of controlling the electrified vehicle.

### DESCRIPTION OF RELATED ART

Electrified vehicles may be provided with the main battery provided as the primary energy source for the motor drive and an auxiliary battery provided as a power source for electric loads or a supplementary energy source for the motor drive.

The main battery and the auxiliary battery may be charged simultaneously by an external direct current voltage during rapid charging. A controller that controls their charging may consider the state of charge (SOC) and durability of each battery to minimize the time required for fully charging the batteries.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

The present disclosure aims to resolve the technical issue of equalizing the durability of the batteries and optimizing the time for fully charging the batteries by setting the charging amount for each of batteries based on the SOC value and the charging limit of the respective batteries in an electrified vehicle provided with a main battery and an auxiliary battery.

The technical objects that the present disclosure aims to achieve are not limited to the technical objects described above, and other technical objects not mentioned will be clearly understood by those skilled in the art from the following description.

Various aspects of the present disclosure are directed to providing an electrified vehicle including first and second batteries, a power conversion device connected between the first and second batteries, and a controller that calculates the charging current command values for the first and second batteries from the value of the external charging current based on the charging limit currents for the first and second batteries and the charging current allocation ratio determined by the SOC value of the first and second batteries and is configured to control the power conversion device to allocate the external charging current to the first and second batteries according to the charging current command value.

In one example, the controller may calculate the remaining charge capacity of the first battery based on the SOC value of the first battery, calculate the remaining charge capacity of the second battery based on the SOC value of the second battery, and set the ratio of the remaining charge capacities of the first and second batteries to be the charging current allocation ratio.

In one example, the controller may allocate the value of the external charging current according to the charging current allocation ratio to calculate the charging current allocation values for the first and second batteries and compare the charging current allocation value with the charging limit current value to set the charging current command value based on the comparison result.

In one example, when the charging current allocation value for the first battery is equal to or less than the charging limit current value for the first battery and the charging current allocation value for the second battery is equal to or less than the charging limit current value for the second battery, the controller may set the charging current allocation value for the first battery to be the charging current command value for the first battery and set the charging current allocation value for the second battery to be the charging current command value for the second battery.

In one example, when the charging current allocation value for the first battery exceeds the charging limit current value for the first battery and the charging current allocation value for the second battery exceeds the charging limit current value for the second battery, the controller may set the charging limit current value for the first battery to be the charging current command value for the first battery and set the charging limit current value for the second battery to be the charging current command value for the second battery.

In one example, when the charging current allocation value for the first battery exceeds the charging limit current value for the first battery and the charging current allocation value for the second battery is equal to or less than the charging limit current value for the second battery, the controller may set the charging limit current value for the first battery to be the charging current command value for the first battery and set a smaller value between the charging limit current value for the second battery and a sum of the charging current allocation value for the second battery and the remaining current allocation value for the first battery to be the charging current command value for the second battery. The remaining current allocation value for the first battery may correspond to a difference between the charging current allocation value and the charging limit current value for the first battery.

In one example, when the charging current allocation value for the first battery is equal to or less than the charging limit current value for the first battery and the charging current allocation value for the second battery exceeds the charging limit current value for the second battery, the controller may set the charging limit current value for the second battery to be the charging current command value for the second battery and set a smaller value between the charging limit current value for the first battery and a sum of the charging current allocation value for the first battery and a remaining current allocation value for the second battery to be the charging current command value for the first battery. The remaining current allocation value for the second battery may correspond to the difference between the charging current allocation value and the charging limit current value for the second battery.

In one example, when at least either the charging limit current value or the SOC changes, the controller may redetermine the charging current command value.

Furthermore, as a means for resolving the above technical issues, a method of controlling an electrified vehicle may include determining a charging current allocation ratio determined by the SOC value of the first and second batteries, calculating the charging current command values for the first and second batteries from a value of an external charging current based on charging limit currents for the first and second batteries and the charging current allocation ratio, and controlling a power conversion device connected between the first and second batteries to allocate the external charging current to the first and second batteries according to the charging current command value.

In one example, the determining of the charging current allocation ratio may include calculating the remaining charge capacity of the first capacity based on the SOC value of the first battery, calculating the remaining charge capacity of the second battery based on the SOC value of the second battery, and setting a ratio of the remaining charge capacities of the first and second batteries to be the charging current allocation ratio.

In one example, the calculating the charging current command value may include allocating the value of the external charging current according to the charging current allocation ratio to calculate the charging current allocation values for the first and second batteries and comparing the charging current allocation value with the charging limit current value to set the charging current command value based on the comparison result.

In one example, the setting of the charging current command value may be performed to set the charging current allocation value for the first battery to be the charging current command value for the first battery and set the charging current allocation value for the second battery to be the charging current command value for the second battery when the charging current allocation value for the first battery is equal to or less than the charging limit current value for the first battery and the charging current allocation value for the second battery is equal to or less than the charging limit current value for the second battery.

In one example, the setting of the charging current command value may be performed to set the charging limit current value for the first battery to be the charging current command value for the first battery and set the charging limit current value for the second battery to be the charging current command value for the second battery when the charging current allocation value for the first battery exceeds the charging limit current value for the first battery and the charging current allocation value for the second battery exceeds the charging limit current value for the second battery.

In one example, the setting of the charging current command value may be performed to set the charging limit current value for the first battery to be the charging current command value for the first battery and set a smaller value between the charging limit current value for the second battery and a sum of the charging current allocation value for the second battery and a remaining current allocation value for the first battery to be the charging current command value for the second battery when the charging current allocation value for the first battery exceeds the charging limit current value for the first battery and the charging current allocation value for the second battery is equal to or less than the charging limit current value for the second battery. The remaining current allocation value for the first battery may correspond to a difference between the charging current allocation value and the charging limit current value for the first battery.

In one example, the setting of the charging current command value may be performed to set the charging limit current value for the second battery to be the charging current command value for the second battery and set a smaller value between the charging limit current value for the first battery and a sum of the charging current allocation value for the first battery and a remaining current allocation value for the second battery to be the charging current command value for the first battery when the charging current allocation value for the first battery is equal to or less than the charging limit current value for the first battery and the charging current allocation value for the second battery exceeds the charging limit current value for the second battery. The remaining current allocation value for the second battery may correspond to the difference between the charging current allocation value and the charging limit current value for the second battery.

In one example, the method of controlling the electrified vehicle may further include redetermining the charging current command value when at least either the charging limit current value or the SOC changes.

According to an exemplary embodiment of the present disclosure, the durability of the batteries may be equalized and the time for fully charging the batteries may be optimized by setting the charging amount for each of batteries based on the SOC value and the charging limit of the respective batteries in an electrified vehicle provided with a main battery and an auxiliary battery.

The effects obtainable from the present disclosure are not limited to the effects mentioned above and other effects not mentioned will be clearly understood by those skilled in the art from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating a configuration of an electrified vehicle according to an exemplary embodiment of the present disclosure.

FIG. 2 is a diagram for describing a power transfer flow of an electrified vehicle in a driving state according to an exemplary embodiment of the present disclosure.

FIG. 3 is a diagram for describing a power transfer flow of an electrified vehicle in a charging state according to an exemplary embodiment of the present disclosure.

FIG. 4 is a block diagram illustrating a control system configuration of an electrified vehicle according to an exemplary embodiment of the present disclosure.

FIG. 5 is a flowchart for describing a method of controlling an electrified vehicle according to an exemplary embodiment of the present disclosure.

FIG. 6 is a flowchart for describing a process of setting a charging current command for an electrified vehicle according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The exemplary embodiments included herein will be described in detail with reference to the accompanying drawings below. However, the same or similar components will be provided the same reference numerals regardless of the drawing numbers, and the repetitive descriptions regarding these components will be omitted.

When it is determined that the specific description of the related and already known technology may obscure the essence of the exemplary embodiments included herein, the specific description will be omitted. Furthermore, it is to be understood that the accompanying drawings are only intended to facilitate understanding of the exemplary embodiments included herein and are not intended to limit the technical ideas included herein are not limited to the accompanying drawings and include all the modifications, equivalents, or substitutions within the spirit and technical scope of the present disclosure. In the following description of embodiments, the term “preset” means that the value of a parameter is predetermined when the parameter is used in a process or algorithm. The value of the parameter may be set at the start of the process or algorithm or may be set while the process or algorithm is performed, depending on the embodiments.

The terms including ordinal numbers such as first, second, and the like may be used to describe various components, but the components are not to be limited by the terms. The terms may only be used for distinguishing one component from another.

It is to be understood that when a component is referred to as being “connected” or “coupled” to another component, the component may be directly connected or coupled to the another component, but other components may be interposed therebetween. In contrast, it is to be understood that when a component is referred to as being “directly connected” or “directly coupled” to another component, NO other component is interposed.

Singular expressions include plural expressions unless the context explicitly indicates otherwise.

In the present specification, terms such as “comprise” or “have” are intended to indicate the presence of implemented features, numbers, steps, manipulations, components, parts, or combinations thereof described in the specification and are not to be understood to preclude the presence or additional possibilities of one or more of other features, numbers, steps, manipulations, components, parts or combinations thereof.

A controller may include a communication device that communicates with other controllers or sensors to control the functions for which the controller is responsible, a memory that stores an operating system or logic instructions and input and output information, and one or more processors that perform determinations, calculations, decisions, and the like necessary for controlling the functions for which the controller is responsible.

The present disclosure proposes an electrified vehicle provided with a main battery and an auxiliary battery and configured to equalize the durability of the batteries and optimize the time for fully charging the batteries by setting the charge amount for each of batteries in consideration of the SOC value and the charging limit for the respective batteries.

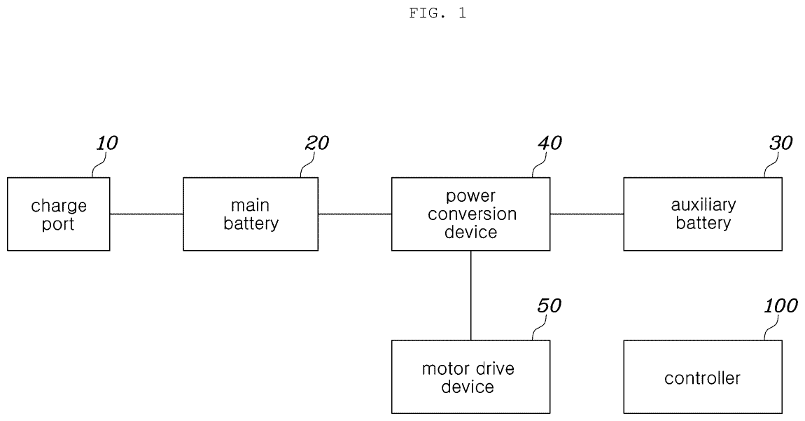

FIG. 1 is a block diagram illustrating a configuration of an electrified vehicle according to an exemplary embodiment of the present disclosure.

FIG. 1 shows that an electrified vehicle according to an exemplary embodiment of the present disclosure may include a charge port 10, a main battery 20, an auxiliary battery 30, a power conversion device 40, a motor drive device 50, and a controller 100. At the instant time, the controller 100 may be implemented as a vehicle control unit (VCU) but is not limited thereto.

The charge port 10 corresponds to a port to be fastened to an external charging device such as electric vehicle supply equipment (EVSE) and may receive an external charging current from the external charging device and transmit the current to the main battery 20.

The main battery 20 and the auxiliary battery 30 may be used as a power source for electric loads or may be used as an energy source for transmitting power to the motor drive device 50.

The power conversion device 40 is connected between the main battery 20 and the auxiliary battery 30, converts the voltage for power control between the main battery 20 and the auxiliary battery 30. The power conversion device 40 may include a bi-directional DC-DC converter.

The motor drive device 50 may drive the motor based on the mechanical energy converted by the power conversion device 40.

The controller 100 may be configured for controlling a power conversion device 40 to allocate an external charging current to the main battery 20 and the auxiliary battery 30 according to the charging current command value.

First, the controller 100 may be configured to determine the charging current command value for the main battery 20 and the auxiliary battery 30 respectively from the value of the external charging current based on the charging limit current for the main battery 20 and the auxiliary battery 30 and the charging current allocation ratio determined by the SOC value of the main battery 20 and the auxiliary battery 30. Here, the value of the external current may be measured by a current sensor provided between the charge port 10 and the main battery 20.

The value of the charging limit current for the main battery 20 may correspond to the upper limit of the charging current command value for the main battery 20, and the value of the charging limit current for the auxiliary battery 30 may correspond to the upper limits of the charging current command value for the auxiliary battery 30. The value of the charging limit current for the main battery 20 and the auxiliary battery 30 may change according to the temperature and the SOC value of the main battery 20 and the auxiliary battery 30.

The charging current allocation ratio may change according to the SOC value of the main battery 20 and the auxiliary battery 30. The controller 100 may be configured to determine the remaining charge capacity of the main battery 20 based on the SOC value of the main battery 20, determine the remaining charge capacity of the auxiliary battery 30 based on the SOC value of the auxiliary battery 30, and set the ratio of the remaining charge capacities of the main battery 20 and the auxiliary battery 30 to be the charging current allocation ratio. For example, when the remaining charge capacity of the main battery 20 corresponds to 40 Ah and the remaining charge capacity of the auxiliary battery 30 corresponds to 10 Ah, the charging current allocation ratio may be 4:1. Another example is the charging current allocation ratio of 3:2 when the remaining charge capacity of the main battery 20 corresponds to 30 Ah and the remaining charge capacity of the auxiliary battery 30 corresponds to 20 Ah.

The controller 100 may allocate value of the external charging current value according to the charging current allocation ratio to determine the charging current allocation value for the main battery 20 and the auxiliary battery 30 respectively. For example, when the value of the external charging current corresponds to 300 A and the charging current allocation ratio corresponds to 4:1, the charging current allocation value for the main battery 20 may correspond to 240 A and the charging current allocation value for the auxiliary battery 30 may correspond to 60 A. In another example, when the value of the external charging current corresponds to 200 A and the charging current allocation ratio corresponds to 3:2, the charging current allocation value for the main battery 20 may correspond to 120 A and the charging current allocation value for the auxiliary battery 30 may correspond to 80 A.

Thereafter, the controller 100 may compare the charging current allocation value and the charging limit current value and set the charging current command value based on the comparison result.

When the charging current allocation value for both the main battery 20 and the auxiliary battery 30 are equal to or less than the charging limit current, the charging current command value may be set equal to the charging current allocation value. When the charging current allocation value for the main battery 20 is equal to or less than the charging limit current value for the main battery 20 and the charging current allocation value for the auxiliary battery 30 is equal to or less than the charging limit current value for the auxiliary battery 30, the controller 100 may set the charging current allocation value for the main battery 20 to be the charging current command value for the main battery 20 and may set the charging current allocation value for the auxiliary battery 30 to be the charging current command value for the auxiliary battery 30.

When the charging current allocation value for both the main battery 20 and the auxiliary battery 30 exceed the charging limit current value, the charging current command value may be set equal to the charging limit current value. When the charging current allocation value for the main battery 20 exceeds the charging limit current value for the main battery 20 and the charging current allocation value for the auxiliary battery 30 exceeds the charging limit current value for the auxiliary battery 30, the controller 100 may set the charging limit current value for the main battery 20 to be the charging current command value for the main battery 20 and may set the charging limit current value for the auxiliary battery 30 to be the charging current command value for the auxiliary battery 30.

When either one of the charging current allocation values for the main battery 20 and the auxiliary battery 30 exceeds the charging limit current value, the controller 100 may readjust the charging current allocation value and set the charging current command value. When the charging current allocation value for the main battery 20 exceeds the charging limit current value for the main battery 20 and the charging current allocation value for the auxiliary battery 30 is equal to or less than the charging limit current value for the auxiliary battery 30, the controller 100 may set the charging limit current value for the main battery 20 to be the charging current command value for the main battery 20 and may set the smaller value between the charging limit current value for the auxiliary battery 30 and the sum of the charging current allocation value for the auxiliary battery 30 and the remaining current allocation value for the main battery 20 (that is, the difference between the charging current allocation value and the charging limit current value for the main battery) to be the charging current command value for the auxiliary battery 30. In contrast, when the charging current allocation value for the main battery 20 is equal to or less than the charging limit current value for the main battery 20 and the charging current allocation value for the auxiliary battery 30 exceeds the charging limit current value for the auxiliary battery 30, the controller 100 may set the charging limit current value for the auxiliary battery 30 to be the charging current command value for the auxiliary battery 30 and may set the smaller value between the charging limit current value for the main battery 20 and the sum of the charging current allocation value for the main battery 20 and the remaining current allocation value for the auxiliary battery 30 (that is, the difference between the charging current allocation value and charging limit current value for the auxiliary battery) to be the charging current command value for the main battery 20.

On the other hand, when at least either the charging limit current value for the main battery 20 and the auxiliary battery 30 or the SOC value of the main battery 20 and the auxiliary battery 30 changes, the controller 100 may redetermine the charging current command value for the main battery 20 and auxiliary battery 30.

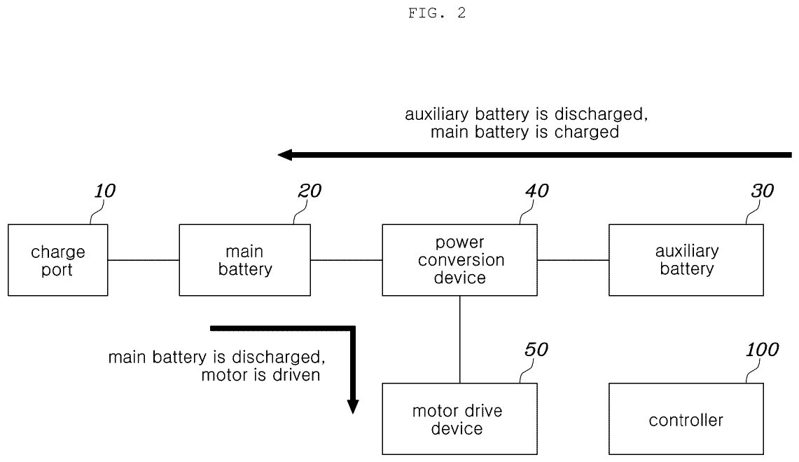

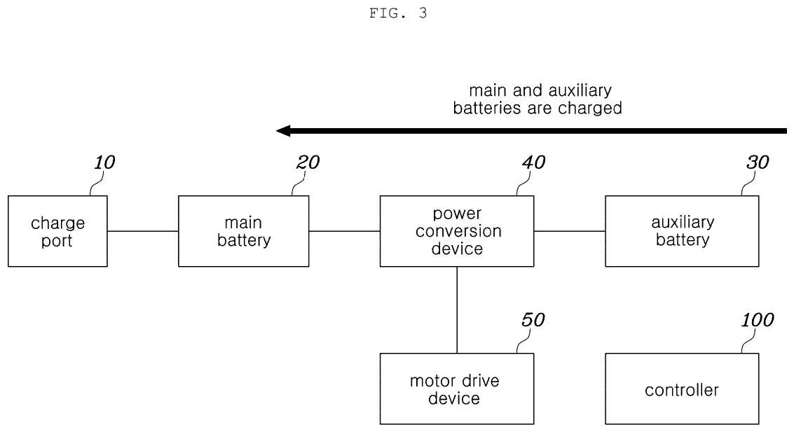

FIG. 2 and FIG. 3 are diagrams for describing a power transfer flow of an electrified vehicle according to an exemplary embodiment of the present disclosure.

FIG. 2 illustrates the power transfer flow of an electrified vehicle in a driving state according to an exemplary embodiment of the present disclosure. In the instant case, the power conversion device 40 may discharge the main battery 20 to supply power to the motor drive device 50 driving the motor and discharge the auxiliary battery 30 to charge the main battery 20.

FIG. 3 illustrates the power transfer flow of an electrified vehicle in a charging state according to an exemplary embodiment of the present disclosure. In the instant case, the main battery 20 may be charged by the external charging current supplied through the charge port 10, and the auxiliary battery 30 may be charged by the power conversion device 40 converting the voltage of the main battery 20.

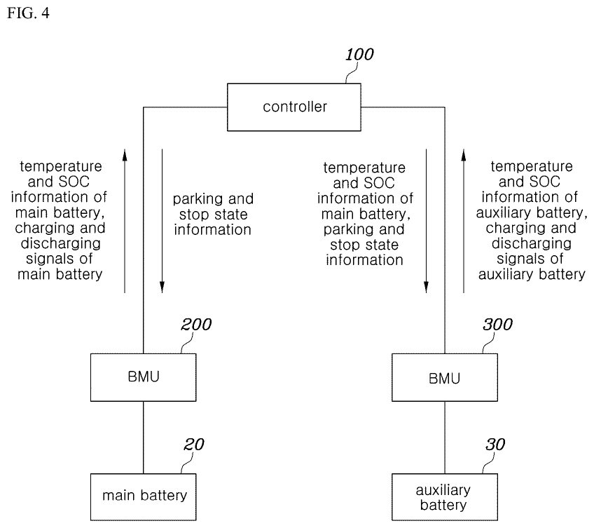

FIG. 4 is a block diagram illustrating a control system configuration of an electrified vehicle according to an exemplary embodiment of the present disclosure.

FIG. 4 shows that the control system configuration of an electrified vehicle according to an exemplary embodiment of the present disclosure may include the controller 100, a first battery management unit (BMU) 200 monitoring and controlling the state of the main battery 20, and a second battery management unit (BMU) 300 monitoring and controlling the state of the auxiliary battery 30. The first BMU 200 may transmit temperature and SOC information of the main battery 20 and the charge and discharge signals related to the main battery 20 to the controller 100 and receive parking and stop state information of the electrified vehicle from the controller 100. At the instant time, the controller 100 may transmit the temperature and SOC information of the main battery 20 received from the first BMU 200 to the second BMU 300. The second BMU 300 may transmit temperature and SOC information of the auxiliary battery 30 and charge and discharge signals related to the auxiliary battery 30 to the controller 100 and receive parking and stop state information of the electrified vehicle from the controller 100.

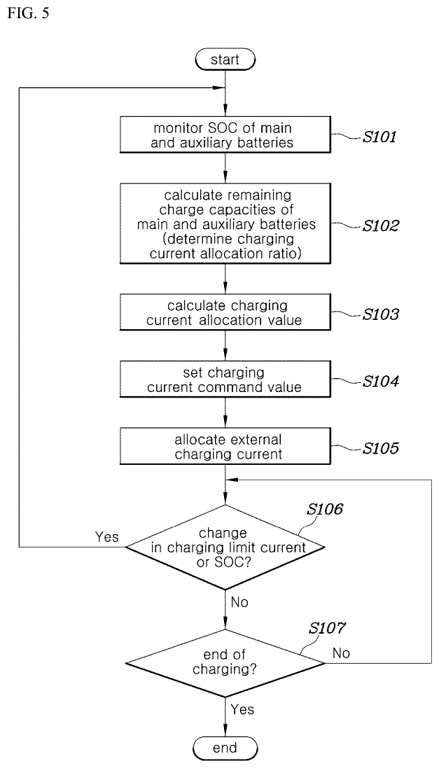

FIG. 5 is a flowchart for describing a method of controlling an electrified vehicle according to an exemplary embodiment of the present disclosure.

FIG. 5 shows that the controller 100 may monitor the SOC value of the main battery 20 and auxiliary battery 30 (S101) and determine the remaining charge capacities of the main battery 20 and auxiliary battery 30 based on the SOC (S102). At the instant time, the charging current allocation ratio may be set to be the remaining charge capacity ratio of the main battery 20 and auxiliary battery 30. The controller 100 may obtain the SOC value of the main battery 20 and auxiliary battery 30 from a respective battery management unit (BMU) or a battery management system (BMS) provided in each of the first battery 20 and the second battery 30.

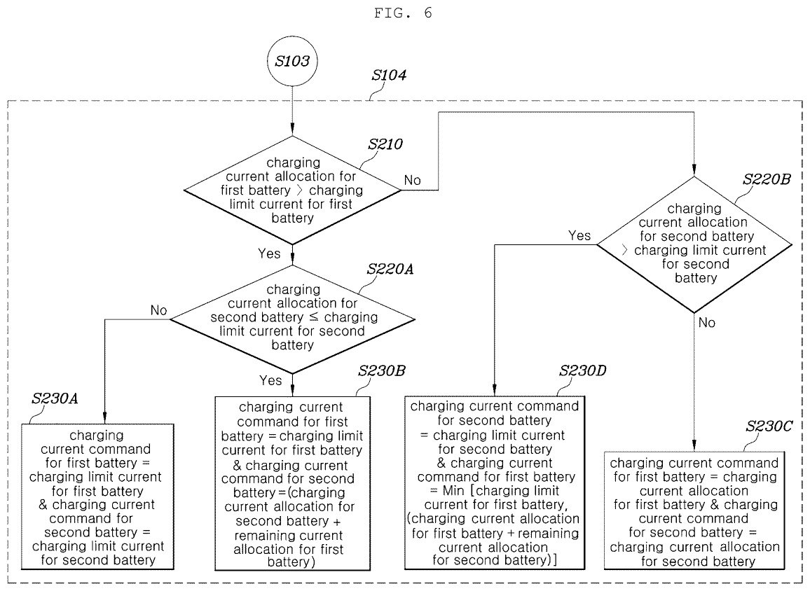

The controller 100 may be configured to determine the charging current command value for the main battery 20 and the auxiliary battery 30 from the value of the external charging current based on the charging limit current for the main battery 20 and the auxiliary battery 30 and the charging current allocation ratio (S103, S104). The controller 100 may allocate the value of the external charging current according to the charging current allocation ratio to determine the charging current allocation value for the main battery 20 and the auxiliary battery 30 respectively (S103) and may compare the charging current allocation value and the charging limit current value to set the charging current command value based on the comparison result (S104). Setting the charging current command value will be described in detail with reference to FIG. 6 below.

Thereafter, the controller 100 may be configured for controlling the power conversion device 40 connected between the main battery 20 and the auxiliary battery 30 to allocate an external charging current to the main battery 20 and the auxiliary battery 30 according to charging current command value (S105).

When at least either of the charging limit current value for the main battery 20 and the auxiliary battery 30 or the SOC value of the main battery 20 and the auxiliary battery 30 changes (YES in S106), the controller 100 may repeat S101 to S105 to redetermine the charging current command value for the main battery 20 and the auxiliary battery 30.

When there is NO change (NO in S106), the controller 100 may be configured to determine whether or not to terminate charging (S107).

FIG. 6 is a flowchart for describing a process of setting a charging current command for an electrified vehicle according to an exemplary embodiment of the present disclosure. For the sake of convenience, the first battery is assumed to be the main battery 20, and the second battery is assumed to be the auxiliary battery 30.

As described above with reference to FIG. 5, the controller 100 may allocate the value of the external charging current according to the charging current allocation ratio to determine the charging current allocation value for the main battery 20 and auxiliary battery 30 respectively (S103) and compare the charging current allocation value and the charging limit current value to set the charging current command value based on the comparison result (S104).

A more detailed description of step S104 with reference to FIG. 6 is as follows. When the charging current allocation value for the first battery exceeds the charging limit current value for the first battery (YES in S210) and the charging current allocation value for the second battery is equal to or less than the charging limit current value for the second battery (YES in S220A), the controller 100 may set the charging limit current value for the first battery to be the charging current command value for the first battery and may set the smaller value between the charging limit current value for the second battery and the sum of charging current allocation value for the second battery and the remaining current allocation value for the first battery (that is, the difference between the charging current allocation value and the charging limit current value for the first battery) to be the charging current command value for the auxiliary battery 30 (S230B).

In contrast, when the charging current allocation value for the first battery is equal to or less than the charging limit current value for the first battery (NO in S210) and the charging current allocation value for the second battery exceeds the charging limit current value for the second battery (YES in S220B), the controller 100 may set the charging limit current value for the second battery to be the charging current command value for the second battery and set a smaller value between the charging limit current value for the first battery and a sum of the charging current allocation value for the first battery and a remaining current allocation value for the second battery (that is, the difference between the charging current allocation value and charging limit current value for the second battery) to be the charging current command value for the first battery 20 (S230D).

Furthermore, when the charging current allocation value for the first battery exceeds the charging limit current value for the first battery (YES in S210) and the charging current allocation value for the second battery exceeds the charging limit current value for the second battery (NO in S220A), the controller 100 may set the charging current command for each battery to be the charging limit current for each battery (S230A).

On the other hand, when the charging current allocation value for the first battery is equal to or less than the charging limit current value for the first battery (NO in S210) and the charging current allocation value for the second battery is equal to or less than the charging limit current value for the second battery (NO in S220B), the controller 100 may set the charging current command for each battery to be the charging current allocation for each battery (S230C).

On the other hand, the present disclosure may be implemented as a computer-readable code on a medium on which a program is recorded. A computer-readable medium includes all types of recording device that stores data which may be read by a computer system. Examples of computer-readable media are a Hard Disk Drive (HDD), a solid state disk (SSD), a silicon disk drive (SDD), ROM, RAM, CD-ROM, a magnetic tape, a floppy disk, an optical data storage device, and the like. Accordingly, the above detailed description is not to be construed in a restricted detect and is to be considered illustrative. The scope of the present disclosure is to be determined by a reasonable interpretation of the appended claims, and all modifications within the equivalent scope of the present disclosure are to be included in the scope of the present disclosure.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An electrified vehicle comprising:
a first battery and a second battery:
a power conversion device electrically connected between the first battery and the second battery; and
a controller operatively connected to the power conversion device and configured to:
determine charging current command values for the first battery and the second battery from a value of an external charging current based on charging limit currents for the first battery and the second battery and a charging current allocation ratio determined by state of charge (SOC) values of the first battery and second battery, and
control the power conversion device to allocate the external charging current to the first battery and the second battery according to the charging current command values.

2. The electrified vehicle of claim 1, wherein the controller is further configured to determine a remaining charge capacity of the first battery based on the SOC value of the first battery, determine a remaining charge capacity of the second battery based on the SOC value of the second battery, and set a ratio of the remaining charge capacities of the first battery and the second battery to be the charging current allocation ratio.

3. The electrified vehicle of claim 1, wherein the controller is further configured to allocate a value of the external charging current according to the charging current allocation ratio to determine charging current allocation values for the first battery and the second battery and compare the charging current allocation value and the charging limit current values to set the charging current command values based on a result of the comparing.

4. The electrified vehicle of claim 3, wherein in response that the charging current allocation value for the first battery is equal to or less than the charging limit current value for the first battery and the charging current allocation value for the second battery is equal to or less than the charging limit current value for the second battery, the controller is further configured to set the charging current allocation value for the first battery to be the charging current command value for the first battery and set the charging current allocation value for the second battery to be the charging current command value for the second battery.

5. The electrified vehicle of claim 3, wherein in response that the charging current allocation value for the first battery exceeds the charging limit current value for the first battery and the charging current allocation value for the second battery exceeds the charging limit current value for the second battery, the controller is further configured to set the charging limit current value for the first battery to be the charging current command value for the first battery and set the charging limit current value for the second battery to be the charging current command value for the second battery.

6. The electrified vehicle of claim 3,
wherein in response that the charging current allocation value for the first battery exceeds the charging limit current value for the first battery and the charging current allocation value for the second battery is equal to or less than the charging limit current value for the second battery, the controller is further configured to set the charging limit current value for the first battery to be the charging current command value for the first battery and set a smaller value between the charging limit current value for the second battery and a sum of the charging current allocation value for the second battery and a remaining current allocation value for the first battery to be the charging current command value for the second battery, and
wherein the remaining current allocation value for the first battery corresponds to a difference between the charging current allocation value and the charging limit current value for the first battery.

7. The electrified vehicle of claim 6,
wherein in response that the charging current allocation value for the first battery is equal to or less than the charging limit current value for the first battery and the charging current allocation value for the second battery exceeds the charging limit current value for the second battery, the controller is further configured to set the charging limit current value for the second battery to be the charging current command value for the second battery and set a smaller value between the charging limit current value for the first battery and a sum of the charging current allocation value for the first battery and a remaining current allocation value for the second battery to be the charging current command value for the first battery, and
wherein the remaining current allocation value for the second battery corresponds to a difference between the charging current allocation value and the charging limit current value for the second battery.

8. The electrified vehicle of claim 1, wherein the controller is further configured to redetermine the charging current command value in response that at least either of the charging limit current values or the SOCs changes.

9. A method of controlling an electrified vehicle, the method comprising:
determining, by a controller, a charging current allocation ratio determined by state of charge (SOC) values of a first battery and a second battery:
determining, by the controller, charging current command values for the first battery and the second battery from a value of an external charging current based on charging limit currents for the first and second batteries and the charging current allocation ratio; and
controlling, by the controller, a power conversion device connected between the first battery and the second battery operatively connected to the power conversion device, to allocate the external charging current to the first battery and the second battery according to the charging current command values.

10. The method of claim 9, wherein the determining of the charging current allocation ratio includes determining a remaining charge capacity of the first battery based on the SOC value of the first battery, determining a remaining charge capacity of the second battery based on the SOC value of the second battery, and setting a ratio of the remaining charge capacities of the first battery and the second battery as the charging current allocation ratio.

11. The method of claim 9, wherein the determining of the charging current command value includes allocating a value of the external charging current according to the charging current allocation ratio to determine charging current allocation values for the first battery and the second battery and comparing the charging current allocation values and the charging limit current values to set the charging current command values based on a result of the comparing.

12. The method of claim 11, wherein the setting of the charging current command values is performed to set the charging current allocation value for the first battery to be the charging current command value for the first battery and set the charging current allocation value for the second battery to be the charging current command value for the second battery in response that the charging current allocation value for the first battery is equal to or less than the charging limit current value for the first battery and the charging current allocation value for the second battery is equal to or less than the charging limit current value for the second battery.

13. The method of claim 11, wherein the setting of the charging current command values is performed to set the charging limit current value for the first battery to be the charging current command value for the first battery and set the charging limit current value for the second battery to be the charging current command value for the second battery in response that the charging current allocation value for the first battery exceeds the charging limit current value for the first battery and the charging current allocation value for the second battery exceeds the charging limit current value for the second battery.

14. The method of claim 11,
wherein the setting of the charging current command values is performed to set the charging limit current value for the first battery to be the charging current command value for the first battery and set a smaller value between the charging limit current value for the second battery and a sum of the charging current allocation value for the second battery and a remaining current allocation value for the first battery to be the charging current command value for the second battery in response that the charging current allocation value for the first battery exceeds the charging limit current value for the first battery and the charging current allocation value for the second battery is equal to or less than the charging limit current value for the second battery, and
wherein the remaining current allocation value for the first battery corresponds to a difference between the charging current allocation value and the charging limit current value for the first battery.

15. The method of claim 14,
wherein the setting of the charging current command values is performed to set the charging limit current value for the second battery to be the charging current command value for the second battery and set a smaller value between the charging limit current value for the first battery and a sum of the charging current allocation value for the first battery and a remaining current allocation value for the second battery to be the charging current command value for the first battery in response that the charging current allocation value for the first battery is equal to or less than the charging limit current value for the first battery and the charging current allocation value for the second battery exceeds the charging limit current value for the second battery, and
wherein the remaining current allocation value for the second battery corresponds to a difference between the charging current allocation value and the charging limit current value for the second battery.

16. The method of claim 11, further including redetermining the charging current command value in response that at least either the charging limit current values or the SOCs changes.

17. A non-transitory computer-readable recording medium in which a program for executing a method of controlling an electrified vehicle by a processor is recorded, the recording medium storing the program to implement:
determining a charging current allocation ratio determined by state of charge (SOC) values of a first battery and a second battery:
determining charging current command values for the first battery and the second battery from a value of an external charging current based on charging limit currents for the first and second batteries and the charging current allocation ratio; and
controlling a power conversion device connected between the first battery and the second battery to allocate the external charging current to the first battery and the second battery according to the charging current command values.
